(19) United States
(12) Patent Application Publication
(10) Pub. No.: US 2017/0213501 A1
(43) Pub. Date: Jul. 27, 2017

(54) DISPLAY APPARATUS AND DRIVING METHOD THEREOF

(71) Applicant: Samsung Electronics Co., Ltd., Suwon-si (KR)

(72) Inventor: Sung-Jin LIM, Seoul (KR)

(73) Assignee: Samsung Electronics Co., Ltd., Suwon-si (KR)

(21) Appl. No.: 15/333,686

(22) Filed: Oct. 25, 2016

(30) Foreign Application Priority Data
Jan. 25, 2016 (KR) 10-2016-0008685

(51) Int. Cl. G09G 3/20

(52) U.S. Cl. CPC G09G 3/2092; G09G 3/2003; G09G 2300/0823; G09G 2300/0452

(57) ABSTRACT

A display apparatus and driving method are discussed where the display apparatus includes a timing controller configured to output a source control signal for setting a polarity for at least one source driver or for at least one pixel connected to the at least one source driver; a source driving device including the at least one source driver, and configured to receive the source control signal and output a source signal to a pixel electrode connected to the at least one source driver; a gate driving device controlled by the timing controller, and configured to output a gate signal; and a display panel configured to display image data by the source driving device and the gate driving device.

### CROSS-REFERENCE TO RELATED APPLICATIONS

This application claims the benefit of Korean Patent Application No. 10-2016-0008685, filed on Jan. 25, 2016 in the Korean Intellectual Property Office, the disclosure of which is incorporated herein by reference.

### BACKGROUND

1. Field

Embodiments of the present disclosure relate to a display apparatus of providing various images visually for a user, and a method of driving the display apparatus.

2. Description of the Related Art

A display apparatus means equipment including a device of displaying images to display various images visually. Image data that is displayed on the display panel of the display apparatus includes various image data such as images received from web servers, as well as image data received through broadcasting signals. Recently, studies into a method of minimizing image-quality distortion, afterimages, etc. on a display panel are conducted.

### SUMMARY

Therefore, it is an aspect of the present disclosure to provide a display apparatus of controlling polarity setting for each source driver, each pixel, or each group in order to overcome problems of image-quality distortion and horizontal stroke, and a method of driving the display apparatus.

Additional aspects of the disclosure will be set forth in part in the description which follows and, in part, will be obvious from the description, or may be learned by practice of the disclosure.

In accordance with one aspect of the present disclosure, a display apparatus includes a timing controller configured to output a source control signal for setting a polarity for at least one source driver or for at least one pixel connected to the at least one source driver; a source driving device including the at least one source driver, and configured to receive the source control signal and output a source signal to a pixel electrode connected to the at least one source driver; a gate driving device controlled by the timing controller, and configured to output a gate signal; and a display panel configured to display image data by the source driving device and the gate driving device.

Here, the timing controller divides the at least one pixel connected to the at least one source driver into a plurality of groups, and generates a source control signal for setting a polarity for each group such that the balance of polarity is maintained.

Also, the source driving device receives the source control signal from the timing controller, and periodically performs inversion driving on the pixel electrode connected to the at least one source driver.

Also, the timing controller outputs a source control signal for setting a polarity for each of the at least one source driver, for each pixel, or for each group, randomly, so that a common voltage is maintained.

Also, the display apparatus may further include an image processor configured to create color data through an image processing process from content data, and to determine whether a color pattern of the color data corresponds to a color pattern having polarity inclined to any one of a positive polarity or a negative polarity.

Also, if the color pattern of the color data corresponds to the color pattern having the polarity inclined to any one of the positive polarity or the negative polarity, the timing controller outputs a source control signal for setting a polarity for each source driver or for at least one pixel connected to the source driver.

Also, the source driving device is connected to the timing controller by a point-to-point method.

Also, the display apparatus may further include a memory configured to store data about polarity setting for the at least one source driver or for each pixel, data about grouping of the at least one pixel connected to the at least one source driver, and data about polarity setting for each group of the at least one pixel.

In accordance with still another aspect of the present disclosure, a display apparatus includes a source driving device including at least one source driver, and configured to output a grayscale voltage to a pixel electrode connected to the at least one source driver; a controller configured to output a source control signal for setting a polarity for each of the at least one source driver to control operations of the source driving device, or to divide at least one pixel connected to the at least one source driver into at least one group and output a source control signal for setting a polarity for each of the at least one group to control operations of the source driving device; a gate driving device configured to receive a gate control signal from a timing controller, and to output a gate signal; and a display panel configured to display image data by the source driving device and the gate driving device.

In accordance with one aspect of the present disclosure, a method of driving a display apparatus includes outputting a source control signal for setting a polarity for each of a plurality of source drivers or for each of pixels connected to the plurality of source drivers; outputting a source signal for setting a polarity based on the source control signal; and displaying a color based on the source signal to display image data on a display panel.

Here, the outputting of the source control signal further comprises dividing the pixels connected to the plurality of source drivers into a plurality of groups, and generating a source control signal for setting a polarity for each of the plurality of groups.

Also, the outputting of the source signal further comprises outputting a reference reverse signal for periodically performing inversion driving on at least one pixel electrode connected to the plurality of source drivers, based on the source control signal.

Also, the outputting of the source control signal comprises outputting a source control signal for setting a polarity for each of the plurality of source drivers, for each pixel, or for each group, randomly, so that a common voltage is maintained.

Also, the method of driving a display apparatus may further include creating color data through an image processing process from content data, and determining whether a color pattern of the color data corresponds to a color pattern having polarity inclined to any one of a positive polarity or a negative polarity.

Also, the determining of whether the color pattern of the color data corresponds to the color pattern having the polarity inclined to any one of the positive polarity or the negative polarity further comprises outputting a source control signal for setting a polarity for each of the plurality of source drivers or for each of the pixels connected to the plurality of source drivers, if the color pattern of the color data corresponds to the color pattern having the polarity inclined to any one of the positive polarity or the negative polarity.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 shows an external appearance of a display apparatus according to an embodiment of the present disclosure.

FIG. 2 is a control block diagram of a display apparatus according to an embodiment of the present disclosure.

FIG. 3 is a control block diagram of a display unit of a display apparatus according to an embodiment of the present disclosure.

FIGS. 4A and 4B are views for describing a case of changing the polarities of a plurality of source drivers to the same polarity, according to an embodiment of the present disclosure.

FIG. 5 is a view for describing a case in which a common voltage is shifted, according to an embodiment of the present disclosure.

FIGS. 6A and 6B are views for describing a case of adjusting the polarities of pixel electrodes for each source driver, according to an embodiment of the present disclosure.

FIG. 7 is a view for describing an effect obtained when the polarities of pixel electrodes are adjusted for each source driver, according to an embodiment of the present disclosure.

FIGS. 8A, 8B, 9A, and 9B are views for describing various methods for adjusting the polarities of pixel electrodes, according to various embodiments of the present disclosure. The following description will be given with reference to all of FIGS. 1 to 9 in order to avoid duplication of description.

FIG. 10 is a view for describing the operation flow of a display apparatus according to an embodiment of the present disclosure.

### DETAILED DESCRIPTION

Reference will now be made in detail to the embodiments, examples of which are illustrated in the accompanying drawings, wherein like reference numerals refer to the like elements throughout. The embodiments are described below by referring to the figures.

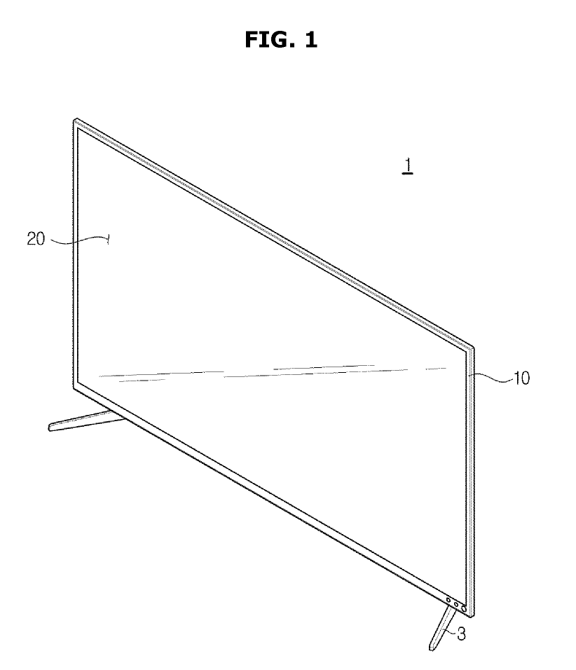

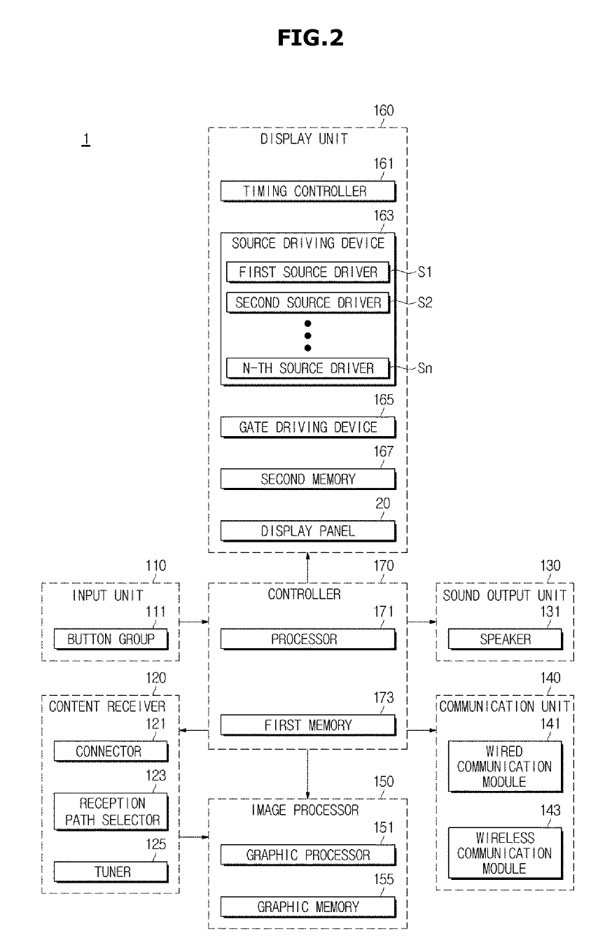

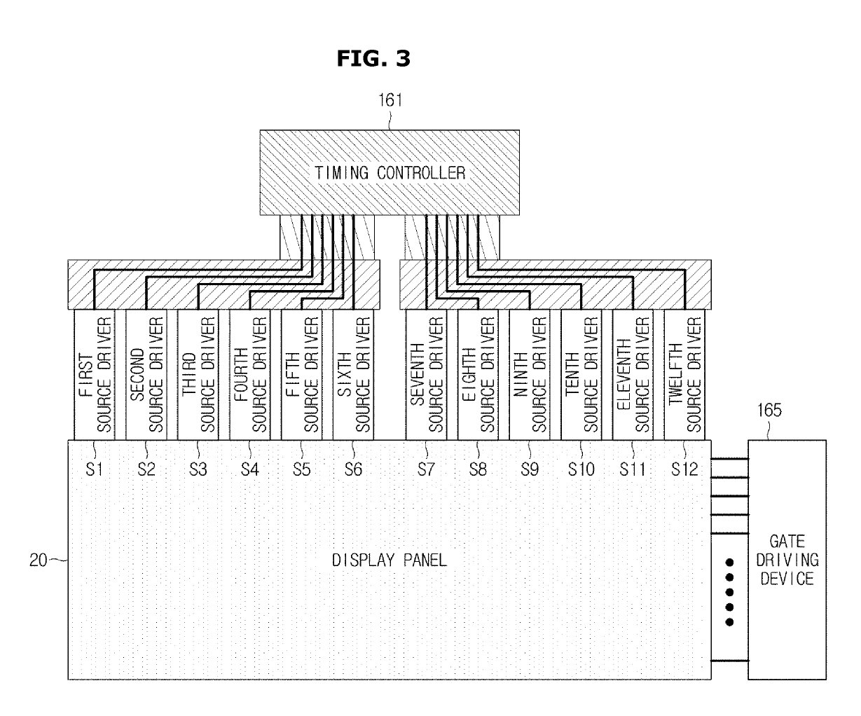

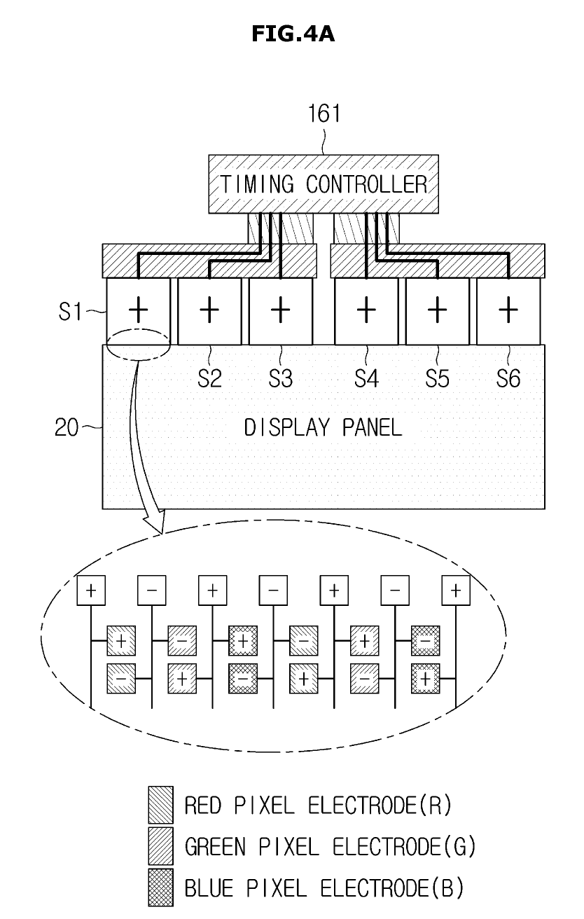

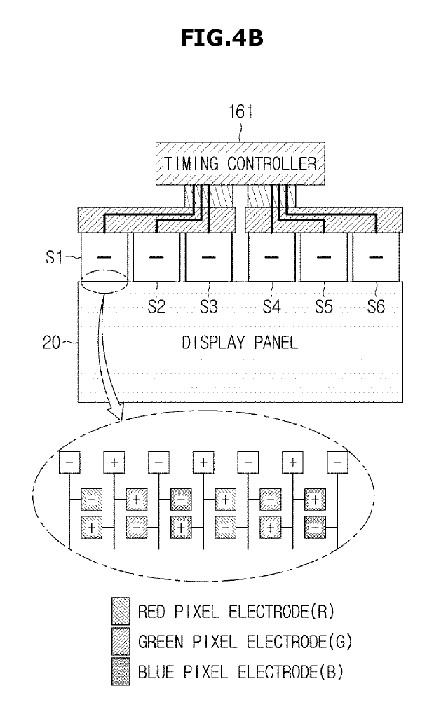

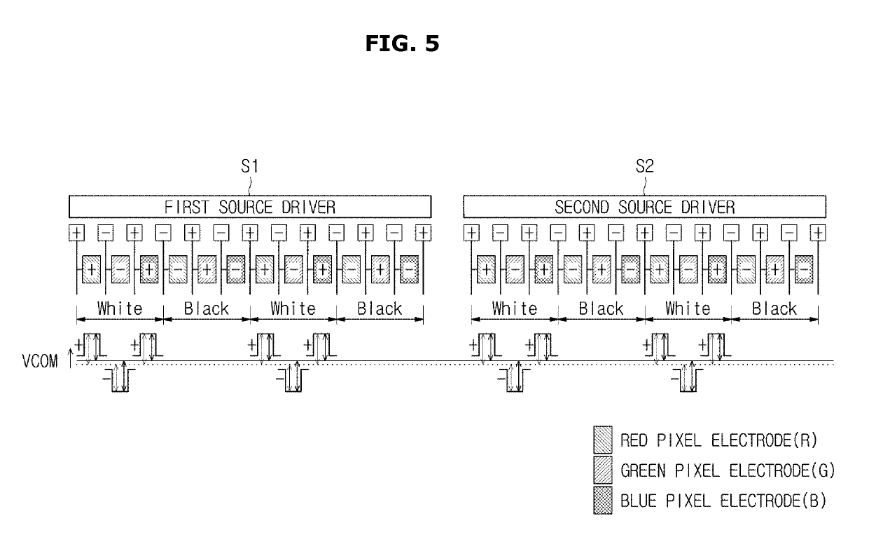

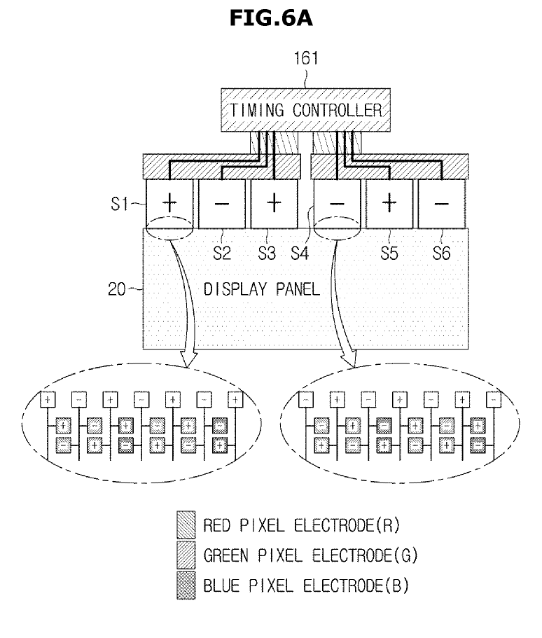

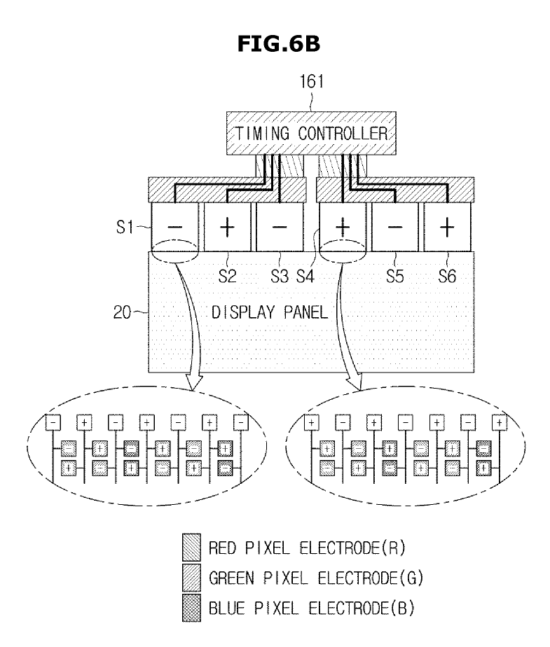

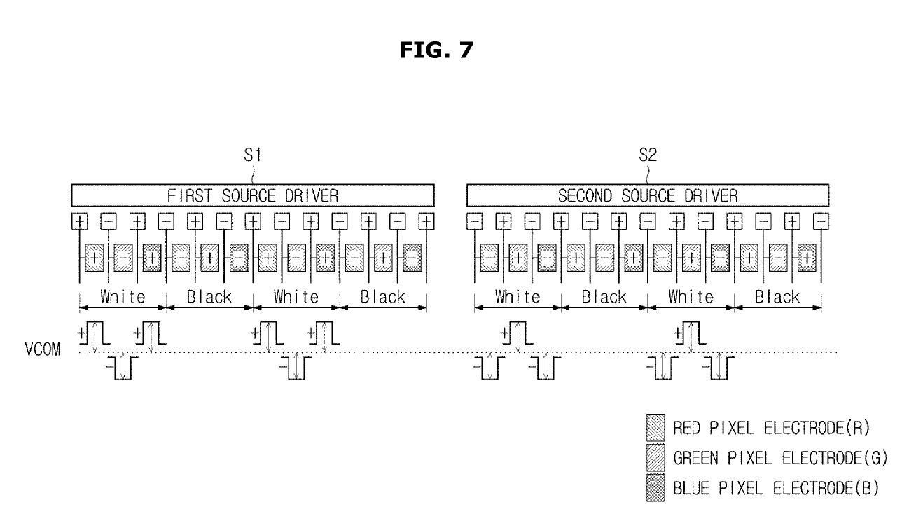

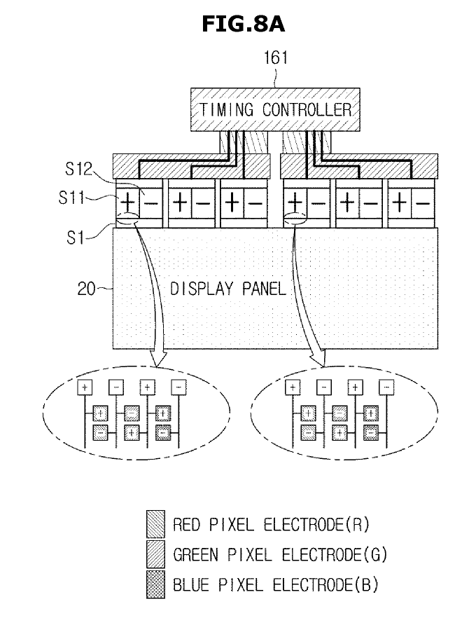

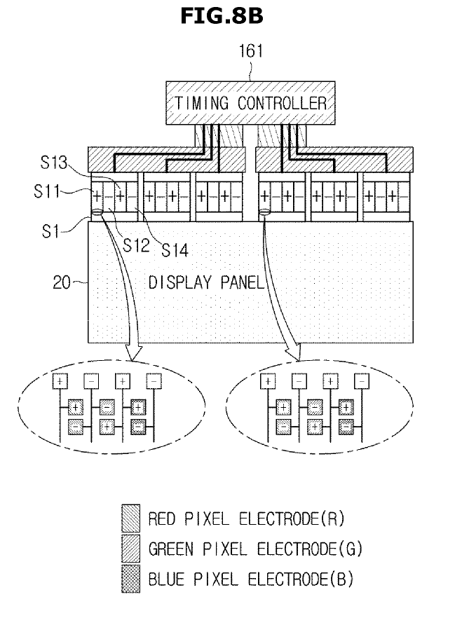

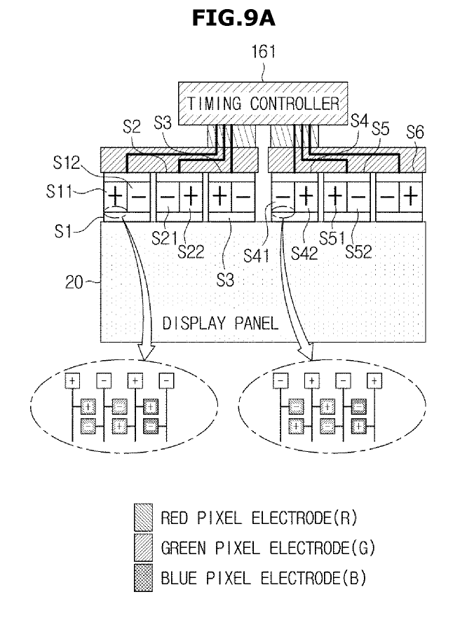

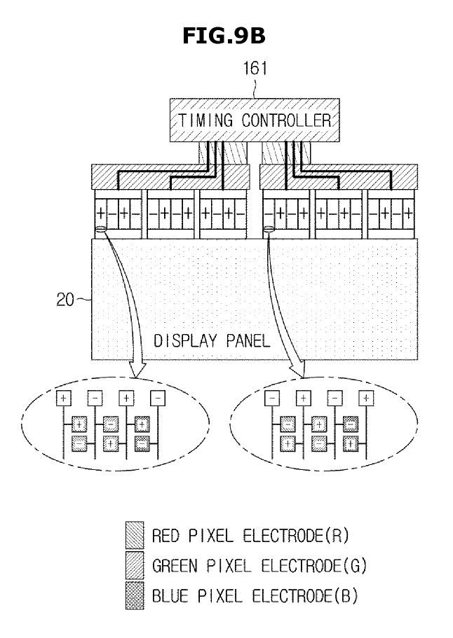

FIG. 1 shows an external appearance of a display apparatus according to an embodiment of the present disclosure, and FIG. 2 is a control block diagram of a display apparatus according to an embodiment of the present disclosure. Also, FIG. 3 is a control block diagram of a display unit of a display apparatus according to an embodiment of the present disclosure, and FIG. 4 is a view for describing a case of changing the polarities of a plurality of source drivers to the same polarity, according to an embodiment of the present disclosure. Also, FIG. 5 is a view for describing a case in which a common voltage is shifted, according to an embodiment of the present disclosure, and FIG. 6 is a view for describing a case of adjusting the polarities of pixel electrodes for each source driver, according to an embodiment of the present disclosure. Also, FIG. 7 is a view for describing an effect obtained when the polarities of pixel electrodes are adjusted for each source driver, according to an embodiment of the present disclosure, and FIGS. 8 and 9 are views for describing various methods for adjusting the polarities of pixel electrodes, according to various embodiments of the present disclosure. The following description will be given with reference to all of FIGS. 1 to 9 in order to avoid duplication of description.

A display apparatus means equipment including a display panel of displaying images to visually display image data of various formats. For example, the display apparatus includes a television (TV), a monitor, and a portable multimedia device, such as Personal Digital Assistant (PDA) and a Portable Multimedia Player (PMP). Also, the display apparatus includes devices embodied in various forms, for example, a portable communication device, such as a smart phone, a wearable device embodied in the shape of glasses or a watch, and so on.

In the following description, a television shown in FIG. 1 will be described as an example of the display apparatus, however, embodiments of the present disclosure are not limited to the television. That is, the embodiments of the present disclosure can be applied to any display apparatus including a display panel to provide various kinds of images visually for a user.

Referring to FIG. 1, a display apparatus 1 may include a main body 10 forming the external appearance of the display apparatus 1 and configured to accommodate various components constituting the display apparatus 1, and a display panel 20 configured to display images for a user.

Meanwhile, the display apparatus 1 shown in FIG. 1 may be implemented as a stand type or a wall-mounted type according to its support type. According to an embodiment, the main body 10 may be implemented as a wall-mounted type that is mounted on a vertical surface such as a wall through a bracket or the like. According to another embodiment, a stand for supporting the main body 10 may be connected to the lower portion of the main body 10 so that the main body 10 can be disposed stably on a flat surface by the stand.

In the front portion of the main body 10, a button group for receiving various control commands from a user, and a display panel 20 for displaying images according to the user's control command may be provided.

Also, in the inside of the main body 10, various components may be installed to perform functions of the display apparatus 1. Hereinafter, a control block diagram of the display apparatus 1 will be described.

Referring to FIG. 2, the display apparatus 1 may include an input unit 110 configured to receive various control commands from the user, a content receiver 120 configured to receive content including images and sound from an external device, a sound output unit 130 configured to output sound corresponding to sound data included in the content, a communication unit 140 configured to transmit and receive various kinds of data such as content through a communication network, an image processor 150 configured to process image data included in the content, a display unit 160 configured to display images corresponding to the image data included in the content, and a controller 170 configured to control overall operations of the display apparatus 1.

At least one of the content receiver 120, the communication unit 140, the image processor 150, a timing controller 161, and the controller 170 may be integrated into a System On Chip (SOC) installed in the display apparatus 1. However, the display apparatus 1 may include two SOCs or more.

The input unit 110 may receive various control commands from the user.

For example, the input unit 110 may include, as shown in FIG. 2, a button group 111. According to an embodiment, the button group 111 may include a volume button to adjust the volume of sound to be output from the sound output unit 150, a channel button to change a communication channel that is received by the content receiver 120, and a power button to turn on/off the display apparatus 1. Also, the input unit 110 may receive various control commands for the display apparatus 1 from the user through the button group 111.

Meanwhile, various kinds of buttons included in the button group 111 may include a push switch and a membrane switch for sensing pressure applied by a user, or a touch switch for sensing a touch input by a user's body part. However, the buttons included in the button group 111 are not limited to the above-described switches or buttons, and the button group 111 may adopt various input means capable of outputting electrical signals in correspondence to a user's specific gestures.

Also, the input unit 110 may include a remote controller to receive a control command from a user remotely, and to transmit the control command to the display apparatus 1. Also, the input unit 110 may include various well-known components capable of receiving control commands from the user. Also, if the display panel 20 is implemented as a touch screen, the display panel 20 may function as the input unit 110.

For example, the input unit 110 may receive a control command for the display apparatus 1 from the user, through the button group 111, the remote controller, or the display panel 20 embodied as a touch screen. Then, the input unit 110 may transfer the received control command to the controller 170, and the controller 170 may control at least one of the components of the display apparatus 1 according to the control signal. The controller 170 will be described in more detail, later.

The content receiver 120 may receive various kinds of content from various external devices. For example, the content receiver 120 may receive content from an antenna of receiving broadcasting signals in a wireless fashion, a set top box of receiving broadcasting signals in a wired or wireless fashion and converting the received broadcasting signals appropriately, and a multimedia reproducing apparatus (for example, a Digital Versatile Disk (DVD) player, a Compact Disk (CD) player, a Blu-ray player, etc.) of reproducing content stored in multimedia storage medium, etc.

More specifically, the content receiver 120 may include a plurality of connectors 121 connected to an external device, a reception path selector 123 to select a path for receiving content from among the plurality of connectors 121, and a tuner 125 to select a channel (or frequency) for receiving broadcasting signals.

The connectors 121 may include an RF coaxial cable connector to receive broadcasting signals including content from an antenna, a High Definition Multimedia Interface (HDMI) connector to receive content from a set top box or a multimedia reproducing apparatus, a component video connector, a composite video connector, a D-sub connector, etc.

The reception path selector 123 may select a connector for receiving content from among the plurality of connectors 121. For example, the reception path selector 123 may automatically select a connector by which content is received, or may select a connector for receiving content according to a user's control command.

If broadcasting signals are received, the tuner 125 may extract a transmission signal of a predetermined frequency (or channel) from among various signals received by an antenna, etc. In other words, the tuner 125 may select a channel (or a frequency) for receiving content according to a user's command of selecting the channel.

If image data of a channel selected by the tuner 125 is received, the image data may be transferred to the image processor 150. Then, the image processor 150 may perform image processing on the image data to acquire color data, an image control signal, etc. from the image data, and the display unit 160 may restore an image on the display panel 20 based on the color data, the image control signal, etc.

Also, the display apparatus 1 may include the sound output unit 130. The sound output unit 130 may receive sound data from the content receiver 120 according to a control signal from the controller 170, and output sound. The sound output unit 130 may include one or more speakers 131 to convert electrical signals into sound signals.

Meanwhile, the display apparatus 1 may include the communication unit 140, as shown in FIG. 2. The communication unit 140 may include a wireless communication module 143 to support a wireless communication method, and a wired communication module 141 to support a wired communication method, and may support various communication methods.

The communication methods may include a wireless communication method and a wired communication method. The wired communication method means a communication method for transmitting and receiving signals including data in a wireless fashion. The wireless communication method may include various communication methods, such as a 3Generation (3G), 4Generation (4G), a Wireless Local Area Network (WLAN), Wireless-Fidelity (Wi-Fi), Bluetooth, Zigbee, Wi-Fi Direct (WFD), Ultra Wideband (UWB), Infrared Data Association (IrDA), Bluetooth Low Energy (BLE), Near Field Communication (NFC), Z-Wave, etc., although not limited to these.

Also, the wired communication method means a communication method for transmitting and receiving signals including data in a wired fashion. For example, the wired communication method may include Peripheral Component Interconnect (PCI), PCI-express, Universe Serial Bus (USB), etc., although not limited to these. For example, the controller 170 may control operations of the communication unit 140 through a control signal to download various kinds of content through a wired communication network or a wireless communication network, and provide the downloaded content to a user.

Meanwhile, the wired communication module 141 and the wireless communication module 143 may be implemented as separate chips. However, the wired communication module 141 and the wireless communication module 143 may be integrated into a single chip.

Meanwhile, referring to FIG. 2, the display apparatus 1 may include the image processor 150. The image processor 150 may include a graphic processor 151 and a graphic memory 155, as shown in FIG. 2.

The graphic memory 155 may store an image processing program for image processing and processed color data, or may temporarily store image information output from the graphic processor 151 or image information received from the content receiver 120.

The graphic processor 151 may process image data stored in the graphic memory 155 using the image processing program stored in the graphic memory 155 to acquire various kinds of data required for image restoration. For example, the graphic processor 151 may perform image processing on image data among content stored in the graphic memory 155 to acquire an image control signal, color data, etc.

Also, the graphic memory 155 may store data of an application program, an algorithm, etc. for analyzing a color pattern of color data. Also, the graphic memory 155 may store data of a color pattern having polarity inclined to any one of a positive polarity and a negative polarity, so that the graphic processor 151 can determine whether polarity setting is needed for each source driver or for each pixel connected to the source driver, using the data stored in the graphic memory 155.

The timing controller 161 may receive color data and an image control signal deduced by the image processor 150 to control operations of a source driving device 163 and a gate driving device 165 based on the color data and the image control signal, thereby restoring image data on the display panel 20. This operation will be described in detail, later.

Meanwhile, the graphic processor 151 and the graphic memory 155 may be implemented as separate chips. However, the graphic processor 151 and the graphic memory 155 may be integrated into a single chip.

The display apparatus 1 may include the display unit 160. Referring to FIG. 2, the display unit 160 may include the timing controller 161, the source driving device 163, the gate driving device 165, a second memory 167, and the display panel 20.

Herein, the display panel 20 may be implemented as a Cathode Ray Tube (CRT) display panel, a Liquid Crystal Display (LCD) panel, a Light Emitting Diode (LED) panel, an Organic Light Emitting Diode (OLED) panel, a Plasma Display Panel (PDP), a Field Emission Display (FED) panel, etc., although not limited to these. Hereinafter, an LCD panel will be described as an example of the display panel 20, however, the embodiments of the present disclosure which will be described below can be applied to any other type of display panel.

Generally, the LCD panel 20 may display image data by applying an electric field to a liquid crystal layer made of a liquid crystal material having dielectric anisotropy interposed between two substrates to thus adjust the amount of light transmitted through the substrates.

More specifically, since the LCD panel 20 cannot itself emit light, the display unit 140 may include a Back Light Unit (BLU) to irradiate backlight on the LCD panel 20. Accordingly, the display apparatus 1 including the LCD panel 20 may display desired image data by applying an electric field to the liquid crystal layer of the LCD panel 20, and adjusting the intensity of the electric field to adjust the transmittance of backlight transmitted through the liquid crystal layer. The BLU may be implemented as a direct type, an edge type, or various types well-known to one of ordinary skill in the art.

Meanwhile, the display panel 20 may be composed of a plurality of pixels. Herein, the pixel is the smallest unit constituting a screen displayed through the LCD panel 20, and also called a dot. In the following description, for convenience of description, the pixel and the dot will be collectively referred to as a “pixel”. Each pixel may receive an electrical signal representing image data, and output an optical signal corresponding to the received electrical signal. Optical signals output from the plurality of pixels included in the display panel 20 may be combined to display image data on the display panel 20.

Each pixel may include a pixel electrode, and be connected to a gate line and a source line. The gate line and the source line may be configured by a method well-known to those skilled in the art, and accordingly, detailed descriptions thereof will be omitted.

Hereinafter, a method of displaying image data on each pixel of the display apparatus 1 including the LCD panel 20 will be briefly described, and then each of the components of the display unit 160 will be described in detail.

Colors can be represented according to various methods. For example, colors can be represented according to a RGB (Red, Green, Blue) method or a YUV (YCbCr) method of representing colors using brightness and color differences. Hereinafter, an example of representing colors using the RGB method will be described; however, the embodiments of the present disclosure which will be described below can be applied to display apparatuses using any other well-known methods, such as the YUV method, capable of representing colors.

The amount of light transmitted through or reflected from the liquid crystal material may depend on a voltage. More specifically, an amount by which light irradiated from the BLU is transmitted through or reflected from the liquid crystal material may change according to a voltage applied to the corresponding pixel electrode.

For example, each pixel may include a first pixel electrode, a second pixel electrode, and a third pixel electrode. According to an embodiment, when the color of image data is represented according to the RGB method, each pixel may include a red pixel electrode, a green pixel electrode, and a blue pixel electrode.

According to the RGB method, a desired color can be represented by combining red, green, and blue. Accordingly, by adjusting the amount of light transmitted through the red pixel electrode, the green pixel electrode, and the blue pixel electrode displaying the respective colors, various colors can be represented. That is, since levels of voltages respectively applied to the red pixel electrode, the green pixel electrode, and the blue pixel electrode decide a color to be displayed on the corresponding pixel, levels of voltages respectively applied to the red pixel electrode, the green pixel electrode, and the blue pixel electrode may be adjusted to display a desired color on the corresponding pixel.

For this, an on/off signal may be sequentially applied to gate lines, and switching devices connected to the gate lines may be sequentially turned on/off. Also, color data to be displayed on pixels corresponding to each gate line may be converted into a plurality of grayscale voltages, and then the plurality of grayscale voltages may be applied to the respective source lines. For one frame period, a gate signal may be sequentially applied to all the gate lines, and source signals, that is, grayscale voltages may be applied to all the pixels so that image data for a frame is displayed on the LCD panel 20.

According to an embodiment, the switching devices may be Thin Film Transistors (TFTs). However, the switching devices may be any other devices well-known to those skilled in the art. Each pixel may rotate liquid crystals of the liquid crystal layer by an electric field formed between a pixel electrode to which a grayscale voltage is applied through a TFT and a common electrode to which a common voltage Vcom is applied so as to adjust the transmittance of light, thereby displaying image data.

Meanwhile, if an electric field of the same direction, that is, the same polarity continues to be applied to the pixel electrodes of the display apparatus 1, an afterimage may remain due to the characteristics of the liquid crystal material, resulting in deterioration of image quality. Accordingly, it is necessary to reverse the polarity of the grayscale voltage with respect to the common voltage Vcom.

The polarity of the grayscale voltage may be decided as a positive polarity or a negative polarity with respect to the common voltage Vcom. For example, if a certain pixel receives a grayscale voltage of a positive polarity for a predetermined frame, the pixel may need to receive a grayscale voltage of a negative polarity for another predetermined frame. That is, the polarity of a grayscale voltage applied to a specific pixel may need to change between a positive polarity and a negative polarity repeatedly. The polarity of the grayscale voltage may be sequentially inverted at an interval of a frame, at an interval of a plurality of frames, or at a specific frame. That is, a cycle at which the polarity of the grayscale voltage is inverted is not limited.

Accordingly, the LCD panel 20 may use a driving method such as a dot inversion driving method of inverting a polarity according to an inversion cycle. However, the dot inversion driving method has a disadvantage in which a common voltage is distorted at a specific pattern or in a continuous use.

For example, if negative voltages are more than positive voltages or positive voltages are more than negative voltages with respect to a common voltage for one horizontal line on the LCD panel 20, that is, if the unbalance of polarity occurs, the level of the common voltage may change so that image-quality distortion and horizontal crosstalk can occur.

According to an embodiment, the dot inversion driving method may be used to sequentially drive first to sixth source drivers S1, S2, S3, S4, S5, and S6 to apply a grayscale voltage of positive polarity to pixels connected thereto, as shown in FIG. 4A, and to apply a grayscale voltage of negative polarity to the pixels, according to an inversion cycle, as shown in FIG. 4B.

The first source driver S1 and the second source driver S2 will be described in detail, below. As shown in FIG. 5, positive voltages are more than negative voltages with respect to a common voltage for one horizontal line. In this case, the polarity of the common voltage is inclined to a positive polarity, so that pixel electrodes driven with the negative voltages may be brightened, resulting in image-quality distortion and horizontal crosstalk.

More specifically, as shown in FIG. 5, a white color and a black color may be alternately displayed on one horizontal line of the LCD panel 2. In order to display a white color on a pixel, a grayscale voltage of positive polarity may be applied to the red pixel electrode R and the blue pixel electrode B of the pixel, and a grayscale voltage of negative polarity may be applied to the green pixel electrode G of the pixel so that a common voltage shifts to a positive polarity. Accordingly, the luminance of green color, that is, the brightness of green color may be relatively brightened so that a greenish phenomenon may occur in which the screen of the LCD panel 20 becomes greenish.

That is, if more grayscale voltages of specific polarity are applied to the pixel electrodes of the LCD panel 20 than grayscale voltages of the opposite polarity, an afterimage may remain due to the characteristics of the liquid crystal material. For this reason, the display apparatus 1 may need to set polarities more properly in consideration of a color distribution pattern, etc. in a frame, and then perform inversion driving in order to prevent image-quality deterioration.

In order to overcome the above-described problem, the display apparatus 1 according to an embodiment can adjust the polarities of the individual source drivers included in the source driving device 163, independently, and also adjust the polarities of the individual pixels connected to the source drivers. Also, the display apparatus 1 according to an embodiment may divide the pixels connected to the source drivers in units of groups or blocks, and adjust a polarity for each group or block. Hereinafter, components of the display unit 160 to perform the above-described control operation will be described in detail.

The display unit 160 may receive an image control signal and color data from the image processor 150, and drive the display panel 20 based on the received color data to display image data. The display unit 160 may include, as shown in FIG. 2, the gate driving device 165, the source driving device 163, the timing controller 161 to transfer a gate control signal and a source control signal to control overall operations of the gate driving device 165 and the source driving device 163, and the second memory 167.

Also, the display unit 160 may include a plurality of gate lines transferring gate signals, a plurality of source lines intersecting with the gate lines and transferring color data, and the LCD panel 20 including a plurality of pixel electrodes formed in the form of a matrix in areas defined by the gate lines and the source lines and connected to each other through the switching devices functioning as switches between the gate lines and the data lines.

The timing controller 161 may receive an image control signal including color data and control information for displaying colors, from the image processor 150. For example, the image control signal may include a vertical synchronization signal Vsync, a horizontal synchronization signal Hsync, a main clock MCLK, and a data enable signal DE.

Then, the timing controller 161 may generate a gate control signal for controlling the gate driving device 165 and a source control signal for controlling the source driving device 163, based on the received image control signal. For example, the timing controller 161 may output the source control signal and the color data to the source driving device 163, and output the gate control signal to the gate driving device 165.

The source control signal may include a polarity control signal including information about polarity settings of the source drivers. The timing controller 161 can control the polarities of source signals that are output from the source driving device 163, based on the polarity control signal. The timing controller 161 can control the polarities of grayscale voltages that are output from the source drivers S1 to Sn included in the source driving device 163, in various ways, based on the polarity control signal.

For example, referring to FIG. 3, the timing controller 161 may be connected to the source drivers S1, S2, S3, S4, S5, S6, S7, S8, S9, S10, S11, and S12 of the source driving device 163, by a point-to-point method. Accordingly, the timing controller 161 may output source control signals to the respective source drivers S1, S2, S3, S4, S5, S6, S7, S8, S9, S10, S11, and S12, thereby setting the polarities of the source drivers S1, S2, S3, S4, S5, S6, S7, S8, S9, S10, S11, and S12, respectively. Meanwhile, the number of the source drivers is not limited to 12 as shown in FIG. 3. That is, the number of the source drivers may be decided according to the specification of the LCD panel 20.

Meanwhile, the timing controller 161 may adjust the polarities of grayscale voltages that are output from the source drivers S1 to Sn included in the source driving device 163, in various ways, based on the polarity control signals, as described above, in order to maintain the balance of polarity.

For example, the timing controller 161 may be set to output grayscale voltages of the same polarity to all the pixel electrodes connected to the source drivers S1 to Sn, through the polarity control signals. According to another example, the timing controller 161 may set a polarity for each of the pixels connected to the source drivers S1 to Sn, through the polarity control signals.

According to another example, the timing controller 161 may divide the pixels connected to the source drivers S1 to Sn in units of groups or blocks, through the polarity control signals, and then set polarity for each group or block. That is, the timing controller 161 may generate polarity control signals for the source drivers S1 to Sn included in the source driving device 163, using various methods, and output the polarity control signals, in order to maintain the balance of polarity.

According to an embodiment, the timing controller 161 may set a positive polarity for a pixel electrode of a pixel connected to the first source driver S1, and set a negative polarity for a pixel electrode of a pixel connected to the second source driver S2, for the same horizontal line, and then output polarity control signals, as shown in FIG. 7. Accordingly, when a white color is displayed, grayscale voltages of positive polarity may be applied to the red pixel electrode R and the blue pixel electrode B connected to the first source driver S1, and a grayscale voltage of negative polarity may be applied to the green pixel electrode G connected to the first source driver S1, whereas grayscale voltages of negative polarity may be applied to the red pixel electrode R and the blue pixel electrode B connected to the second source driver S2, and a grayscale voltage of positive polarity may be applied to the green pixel electrode G connected to the second source driver S2. Accordingly, the timing controller 161 according to an embodiment may maintain a common voltage Vcom for each horizontal line, unlike the case of FIG. 5.

In other words, the timing controller 161 according to an embodiment may set the polarities of grayscale voltages that are output for each source driver, independently, thereby maintaining the balance of polarity while improving image-quality distortion of the LCD panel 20. Meanwhile, the first and second source drivers S1 and S2 may perform inversion driving of inverting polarities according to an inversion cycle. Accordingly, in the next inversion cycle, the first and second source drivers S1 and S2 may apply voltages of polarities that are opposite to the polarities shown in FIG. 7 such that the common voltage Vcom can be maintained for each horizontal line.

Also, the timing controller 161 may set a polarity for each pixel, and output a polarity control signal. Also, the timing controller 161 may divide the pixels connected to the source drivers into at least one group or block, set a polarity for each group or block, and then output a polarity control signal. Each group or block may include at least one pixel, and hereinafter, for convenience of description, the group or block will be collectively referred to as a “group”.

According to an embodiment, the timing controller 161 may divide at least one pixel connected to each source driver into two groups, through a polarity control signal, and set a polarity for each group. Referring to FIG. 8A, the timing controller 161 may divide pixels connected to the first source driver S1 into two groups S11 and S12, and set polarities for the groups S11 and S12 such that voltages of opposite polarities are respectively applied to the groups S11 and S12. That is, the timing controller 161 may output a polarity control signal of setting different polarities for two groups connected to each source driver.

According to another embodiment, the timing controller 161 may divide the pixels connected to the first source driver S1 into four groups S11, S12, S13, and S14, as shown in FIG. 8B. Also, the timing controller 161 may output a polarity control signal of setting polarities for the four groups S11, S12, S13, and S14 such that voltages of opposite polarities are respectively applied to the first and third groups S11 and S13 and the second and fourth groups S12 and S14.

As shown in FIGS. 8A and 8B, the polarities of the groups may be set in order of positive and negative, although not limited to this order. For example, the timing controller 161 may output a polarity control signal of setting polarities for the groups of the first and second source drivers S1 and S2 such that voltages of positive polarity are applied to the first group S11 of the first source driver S1 and the second group S22 of the second source driver S2, and voltages of negative polarity are applied to the second group S12 of the first source driver S1 and the first group S21 of the second source driver S2, as shown in FIG. 9A.

Likewise, when pixels connected to each source driver are divided into four groups, the timing controller 161 may set polarities of the groups of the source drivers in various orders, as shown in FIG. 9A. Also, the timing controller 161 may randomly set a polarity for each source driver or for each group, instead of setting polarities such that a positive polarity and a negative polarity appear sequentially and alternately. That is, the timing controller 161 may appropriately set polarities of voltages that are applied to the source drivers or pixels so that the balance of polarity is maintained to maintain a common voltage.

Also, the number of groups that can be created by the timing controller 161 is not limited to the cases shown in FIGS. 8 and 9, as long as at least two groups can be created. Also, the timing controller 161 may divide pixels into several groups such that the individual groups include different numbers of pixels, as long as the balance of polarity can be maintained.

Meanwhile, the display apparatus 1 may include the second memory 167.

The second memory 167 may store data for a method of setting polarities of pixel electrodes which are applied to pixels. For example, the second memory 167 may store data for an application program for setting a polarity for each source driver, each pixel, or each group, so that the timing controller 161 can perform polarity setting, grouping, etc., based on the data. Meanwhile, the data for the application program stored in the second memory 167 may continue to be updated through the communication unit 140, etc.

Meanwhile, a first memory 173 and the second memory 167 may be implemented as separate chips, or integrated into a single chip. Also, the timing controller 161 and the processor 171 may also be implemented as separate chips, or integrated into a single chip. If the timing controller 161 and the processor 171 are integrated into a single chip, the controller 170 may perform operations of the timing controller 161. That is, the timing controller 161 may be integrated into the controller 170.

Meanwhile, the source driving device 163 may be connected to the timing controller 161 through a wire to receive color data and a source control signal. Accordingly, the source driving device 163 may convert the received color data into an analog signal, and thus output a source signal, that is, a grayscale voltage.

For example, the source driving device 163 may set an output timing of a grayscale voltage, a level and polarity of the grayscale voltage, etc. based on the color data and the source control signal received from the timing controller 161, and then output an appropriate grayscale voltage through a source line according to the output timing. Also, the source driving device 163 may perform inversion driving periodically according to an inversion cycle through a reference reverse signal. For example, the reference reverse signal may include a reverse signal REV or a polarity control signal POL for inverting the polarities of the pixel electrodes connected to the source drivers.

Referring to FIG. 2, the source driving device 163 may include at least one source driver. For example, the source driving device 163 may include the first to n-th source drivers S1 to Sn. The source driver is also called a source driver Integrated Circuit (IC), however, in this specification, for convenience of description, the source driver will be referred to as a “source driver”. The number of the source drivers S1 to Sn may be decided according to the specification of the LCD panel 20, such as the size, resolution, etc. of the LCD panel 20.

For example, as shown in FIG. 3, if the first to twelfth source drivers S1, S2, S3, S4, S5, S6, S7, S8, S9, S10, S11, and S12 are connected to the timing controller 161 by the point-to-point method, each of the first to twelfth source drivers S1, S2, S3, S4, S5, S6, S7, S8, S9, S10, S11, and S12 of the source driving device 163 may receive color data and a source control signal from the timing controller 161. Then, each of the source drivers S1, S2, S3, S4, S5, S6, S7, S8, S9, S10, S11, and S12 may convert the color data into a grayscale voltage of positive or negative polarity according to the source control signal, and supply the grayscale voltage of positive or negative polarity to a pixel electrode connected through a source line.

The source driving device 163 may set a polarity of a source signal such that a positive polarity is balanced with a negative polarity, and output the source signal. In other words, the source driving device 163 may set a polarity of a grayscale voltage that is applied to a pixel electrode such that the balance of polarity is maintained, and apply the grayscale voltage to the pixel electrode through a source line.

For example, as shown in FIG. 6A, the first, third, and fifth source drivers S1, S3, and S5 of the source driving device 163 may output source signals of positive polarity, and the second, fourth, and sixth source drivers S2, S4, and S6 of the source driving device 163 may output source signals of negative polarity. Also, the first, third, and fifth source drivers S1, S3, and S5 and the second, fourth, and sixth source drivers S2, S4, and S6 of the source driving device 163 may output reference reverse signals according to an inversion cycle, thereby performing inversion driving, as shown in FIG. 6B.

More specifically, the display apparatus 1 may include a voltage generator, and the source drivers may interwork with the voltage generator to apply a grayscale voltage to a pixel electrode through a source line. Each source driver may determine an application timing of a grayscale voltage based on a source control signal, apply the grayscale voltage based on the application timing of the grayscale voltage, and also perform inversion driving of inverting the polarity of the grayscale voltage periodically.

Meanwhile, the display apparatus 1 may include the gate driving device 165.

The gate driving device 165 may include one or more gate drivers. The gate driver is also called a gate driver Integrated Circuit (IC), however, for convenience of description, the gate driver will be referred to as a “gate driver”. The number of the gate drivers may be decided according to the specification of the LCD panel 20, such as the size, resolution, etc. of the LCD panel 20.

The gate drivers of the gate driving device 165 may receive gate control signals, and apply an on/off voltage, that is, an on/off signal sequentially through the gate lines. Accordingly, the gate drivers may sequentially turn on/off the switching devices connected to the gate lines.

Accordingly, color data that is to be displayed on the pixels connected to the gate lines may be converted into a plurality of grayscale voltages, and then the plurality of grayscale voltages may be applied to the respective source lines. At this time, gate signals may be sequentially applied to all the gate lines for a frame period so that the grayscale voltages corresponding to the color data are applied to all pixel rows, thereby displaying a frame image on the LCD panel 20.

Meanwhile, the display apparatus 1 may include the controller 170. The controller 170 may include the processor 171 and the first memory 173, as shown in FIG. 2.

The first memory 173 may store a control program and control data for controlling operations of the display apparatus 1, and temporarily store a control command received through the input unit 110 or a control signal output from the processor 171. Accordingly, the processor 171 may process various data stored in the first memory 173 according to the control program stored in the first memory 173.

The processor 171 may control overall operations of the display apparatus 1. The processor 171 may generate control signals for controlling the individual components of the display apparatus 1, and control operations of the individual components.

For example, the processor 171 may control the communication unit 140 based on a control signal to transmit or receive signals including data to or from an external device. According to another embodiment, the processor 171 may transfer a control signal to the sound output unit 130 according to a volume control command received through the input unit 110 to adjust the volume of sound that is output through the speakers 131.

According to another example, the processor 171 may control the image processor 150 to perform image processing on content received from the content receiver 120, and control the display unit 160 to display the image-processed image.

According to an embodiment, the processor 171 may control the image processor 160 based on a control signal to acquire color data and an image control signal from image data of content received from the content receiver 120. Also, the processor 171 may control the image processor 150 and the display unit 160 based on a control signal to display image data on the display panel 20 based on the acquired color data and the image control signal.

The processor 171 and the first memory 173 have been described as separate devices; however, the processor 171 and the memory 173 may be integrated into a single chip. Hereinafter, the operation flow of the display apparatus 1 will be described.

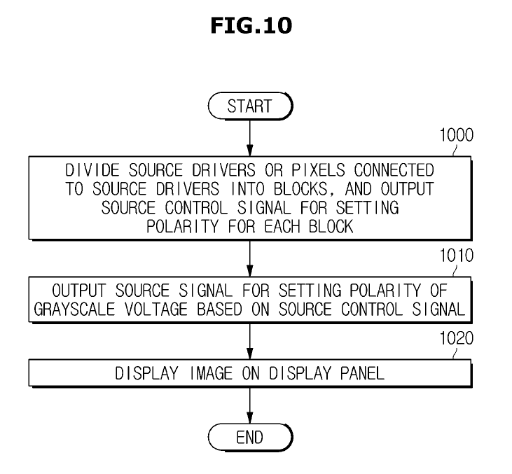

FIG. 10 is a view for describing the operation flow of a display apparatus according to an embodiment of the present disclosure.

In order to display an image on a display panel, a display apparatus may perform an image processing process on content received through a content receiver or a communication unit to acquire color data and an image control signal. Then, the display apparatus may control operations of components in the display apparatus based on the acquired color data and the image control signal to display image data converted to be suitable for a display panel installed in the display apparatus.

For example, the display apparatus may decide a unit for polarity setting, based on the color data and the image control signal. According to an embodiment, the display apparatus may set a polarity in units of source drivers, or in units of pixels connected to the source drivers, in operation 1000. At this time, the display apparatus may divide a plurality of pixels connected to the source drivers into two groups or more, and set a polarity for each group. That is, the display apparatus may set a polarity for each source driver, each pixel in each source driver, or each group, such that the balance of polarity is maintained.

When an image is displayed on a LCD panel, the amount of light transmitted through or reflected from a liquid crystal material may depend on a voltage. More specifically, the transmission/reflection amount of light irradiated from a BLU may change according to a voltage applied to each pixel electrode.

According to an embodiment, when a color is represented according to a RGB method, the color may be created by combining red, green, and blue. Accordingly, by adjusting the amount of light transmitted through a red pixel electrode, a green pixel electrode, and a blue pixel electrode provided for each pixel, various colors can be represented.

According to an embodiment, in the case of a 9V display panel used in a laptop computer or the like, a common voltage is about 4.5V, and if a voltage between about 0V and 4.4V or between 4.6V and 9V is applied to a pixel electrode, a color that is represented on the corresponding pixel may change.

That is, the display apparatus may apply a voltage corresponding to a color to be represented, between 0V and 4.4V or between 4.6V and 9V, to each of a red pixel electrode, a green pixel electrode, and a blue pixel electrode. A voltage needed to be applied to a pixel electrode in order to represent a color is referred to as a grayscale voltage. Also, since a positive polarity or a negative polarity is decided with respect to a common voltage, a voltage between 0V and 4.4V may be decided as a negative polarity, and a voltage between 4.6V and 9V may be decided as a positive polarity. The grayscale voltage may be set in advance according to the specification of the display panel, and information about the grayscale voltage may be stored in advance in a memory installed in the display apparatus. Accordingly, the grayscale voltage is not limited to the example of the 9V display panel.

Accordingly, the display apparatus may output a source control signal including information about polarity settings to a source driver through a timing controller. Also, the display apparatus may output a grayscale voltage, that is, a source signal to a source line according to an application timing based on the source control signal, in operation 1010. Then, the display panel of the display apparatus may receive the source signal to display image data thereon, in operation 1020.

Also, the display apparatus may invert a polarity for each source driver, each pixel, or each group, according to an inversion cycle, based on the set polarity, thereby preventing the generation of an afterimage. At this time, the display apparatus may set the inversion cycle according to various criteria, and invert the set polarity according to the inversion cycle. For example, the display apparatus may perform inversion driving of inverting a polarity whenever a frame changes or whenever a plurality of frames change.

Meanwhile, a driving method of the display apparatus is not limited to the above-described method of setting a polarity for each source driver, each pixel, or each group, and performing inversion driving based on the polarity. For example, if the balance of polarity can be maintained although the same polarity is set for all source drivers included in the display apparatus, the display apparatus may not need to perform operation of setting a polarity for each source driver, each pixel, or each group.

Accordingly, the display apparatus may determine whether a color pattern in an image is a pattern in which the balance of polarity is not maintained, based on color data. According to an embodiment, referring to FIGS. 5 and 6, the display apparatus may determine polarities of voltages applied to pixel electrodes for one horizontal line, and determine whether the balance of polarity is maintained to maintain a common voltage, based on the polarities of the voltages. At this time, whether the balance of polarity is maintained may be determined through an image processing process by an image processor included in the display apparatus.

If it is determined that the balance of polarity is not maintained, the display apparatus may set a polarity for each source driver independently or set a polarity for at least one pixel so that the balance of polarity can be maintained, thereby preventing a polarity from being inclined to any one of positive polarity or negative polarity. Operation of setting a polarity for each source driver, each pixel, or each group may require more computation than operation of setting the same polarity for all the source drivers. Accordingly, the display apparatus according to an embodiment may recognize a color pattern for each frame in image data, and determine whether a polarity needs to be set for each source driver or each pixel, based on the result of the recognition, thereby preventing image-quality distortion, and also preventing overload of computation.

Configurations illustrated in the embodiments and the drawings described in the present specification are only the preferred embodiments of the present disclosure, and thus it is to be understood that various modified examples, which may replace the embodiments and the drawings described in the present specification, are possible when filing the present application.

The terms used in the present specification are used to describe the embodiments of the present disclosure. Accordingly, it should be apparent to those skilled in the art that the following description of exemplary embodiments is provided for illustration purpose only and not for the purpose of limiting the embodiments as defined by the appended claims and their equivalents. It is to be understood that the singular forms “a,” “an,” and “the” include plural referents unless the context clearly dictates otherwise. It will be understood that when the terms “includes,” “comprises,” “including,” and/or “comprising,” when used in this specification, specify the presence of stated features, figures, steps, components, or combination thereof, but do not preclude the presence or addition of one or more other features, figures, steps, components, members, or combinations thereof.

It will be understood that, although the terms first, second, etc. may be used herein to describe various components, these components should not be limited by these terms. These terms are only used to distinguish one component from another. For example, a first component could be termed a second component, and, similarly, a second component could be termed a first component, without departing from the scope of the present disclosure. As used herein, the term “and/or” includes any and all combinations of one or more of associated listed items.

As used herein, the terms “unit”, “device, “block”, “member”, or “module” refers to a unit that can perform at least one function or operation, and may be implemented as a software or hardware component such as a Field Programmable Gate Array (FPGA) or an Application Specific Integrated Circuit (ASIC). However, the term “unit”, “device”, “block”, “member”, or “module” is not limited to software or hardware. The “unit”, “device”, “block”, “member”, or “module” may be stored in accessible storage medium, or may be configured to run on at least one processor.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A display apparatus, comprising:
a timing controller configured to output a source control signal for setting a polarity for one of at least one source driver and at least one pixel connected to the at least one source driver;
a source driving device including the at least one source driver, and configured to receive the source control signal and output a source signal to a pixel electrode connected to the at least one source driver;
a gate driving device controlled by the timing controller, and configured to output a gate signal; and
a display panel configured to display image data using the source driving device and the gate driving device.

2. The display apparatus according to claim 1, wherein the timing controller divides the at least one pixel connected to the at least one source driver into a plurality of groups, and generates a source control signal for setting the polarity for each group to maintain a balance of polarity.

3. The display apparatus according to claim 1, wherein the source driving device receives the source control signal from the timing controller, and periodically performs inversion driving of the pixel electrode connected to the at least one source driver.

4. The display apparatus according to claim 2, wherein the timing controller outputs a source control signal for setting the polarity for one of each of the at least one source driver, each pixel and each group, randomly to maintain a common voltage.

5. The display apparatus according to claim 1, further comprising an image processor configured to create color data through an image processing process from content data, and to determine whether a color pattern of the color data corresponds to the color pattern having the polarity inclined to any one of a positive polarity and a negative polarity.

6. The display apparatus according to claim 5, wherein when the color pattern of the color data corresponds to the color pattern having the polarity inclined to any one of the positive polarity and the negative polarity, the timing controller outputs the source control signal for setting the polarity for one of each source driver and the at least one pixel connected to the source driver.

7. The display apparatus according to claim 1, wherein the source driving device is connected to the timing controller by a point-to-point method.

8. The display apparatus according to claim 1, further comprising a memory configured to store data about a polarity setting for one of the at least one source driver and each pixel, data about grouping of the at least one pixel connected to the at least one source driver, and data about the polarity setting for each group of the at least one pixel.

9. A display apparatus, comprising:
a source driving device including at least one source driver, and configured to output a grayscale voltage to a pixel electrode connected to the at least one source driver;
a controller configured to one of output a source control signal for setting a polarity for each of the at least one source driver to control operations of the source driving device, and to divide at least one pixel connected to the at least one source driver into at least one group and output the source control signal for setting the polarity for each of the at least one group to control operations of the source driving device;
a gate driving device configured to receive a gate control signal from a timing controller, and to output a gate signal; and
a display panel configured to display image data using the source driving device and the gate driving device.

10. A method of driving a display apparatus, comprising:
outputting a source control signal for setting a polarity for one of each of a plurality of source drivers and each of pixels connected to the plurality of source drivers;
outputting a source signal for setting the polarity based on the source control signal; and
displaying a color based on the source control signal to display image data on a display panel.

11. The method according to claim 10, wherein the outputting of the source control signal further comprises dividing the pixels connected to the plurality of source drivers into a plurality of groups, and generating the source control signal for setting the polarity for each of the plurality of groups.

12. The method according to claim 10, wherein the outputting of the source signal further comprises outputting a reference reverse signal for periodically performing inversion driving on at least one pixel electrode connected to the plurality of source drivers, based on the source control signal.

13. The method according to claim 11, wherein the outputting of the source control signal comprises outputting the source control signal for setting the polarity for one of each of the plurality of source drivers, each pixel, and each group, randomly, to maintain a common voltage.

14. The method according to claim 10, further comprising creating color data through an image processing process from content data, and determining whether a color pattern of the color data corresponds to the color pattern having the polarity inclined to any one of a positive polarity and a negative polarity.

15. The method according to claim 14, wherein the determining of whether the color pattern of the color data corresponds to the color pattern having the polarity inclined to any one of the positive polarity and the negative polarity further comprises outputting the source control signal for setting the polarity for one of each of the plurality of source drivers and each of the pixels connected to the plurality of source drivers, when the color pattern of the color data corresponds to the color pattern having the polarity inclined to any one of the positive polarity and the negative polarity.
